(19) United States
(12) Patent Application Publication
(10) Pub. No.: US 2025/0056472 A1
(43) Pub. Date: Feb. 13, 2025

(54) SYSTEMS AND METHODS FOR IMPROVING ACCURACY OF UE LOCATION DETERMINATIONS IN A WIRELESS COMMUNICATIONS NETWORK

(71) Applicant: Lenovo (Singapore) Pte. Limited, Singapore (SG)

(72) Inventors: Dimitrios Karampatsis, Ruislp (GB); Ankit Bhamri, Rödermark (DE); Robin Rajan Thomas, Frankfurt (DE)

(73) Assignee: Lenovo (Singapore) Pte. Limited, Singapore (SG)

(21) Appl. No.: 18/719,977

(22) PCT Filed: Feb. 7, 2022
(86) PCT No.: PCT/EP2022/052848

§ 371 Date: Jun. 14, 2024

(30) Foreign Application Priority Data
Dec. 16, 2021 (GR) 20210100888

(51) Int. Cl. H04W 64/00; H04W 8/22; H04W 24/02

(52) U.S. Cl. CPC H04W 64/00; H04W 8/22; H04W 24/02

(57) ABSTRACT

There is provided a method for a Location Management Function, LMF, in a wireless communication network, the method comprising: receiving a first request to provide a location of one or more user equipment. UEs, wherein the first request includes a first requirement for a minimum location accuracy; for the one or more UEs and/or for a target area in which the one or more UEs are located, acquiring statistics or a prediction that location measurements are based on line-of-sight, LOS, or non-line-of-sight, NLOS, communication with a Radio Access Network, RAN, node in the wireless communication network; responsive to acquiring the statistics or the prediction, determining that the one or more UEs are to use an Artificial Intelligence/Machine Learning, AI/ML, model to perform a location measurement; and sending a second request to the one or more UEs for the one or more UEs to perform a location measurement using the AI/ML model.

### FIELD

The subject matter disclosed herein relates generally to the field of improving the accuracy of user equipment (UE) location determinations in a wireless communication network. The subject matter disclosed herein include methods performed by Location Management Functions (LMFs) coupled to the wireless communication network.

### BACKGROUND

Currently when a consumer requests analytics from a network data analytics function (NWDAF), the consumer may include in the request a target area and/or a target user equipment (UE) or group of UE(s). The NWDAF derives analytics by collecting data/events from one or more Network Functions ensuring the data are from the target area requested or involve the target UE(s). The analytics are derived taking into account a static location of UEs based on an Access and Mobility Management Function (AMF) determining a UE entering or leaving a specific area of interest with a granularity of Tracking Area(s) or Cell ID(s).

In Release 16 and Release 17 3GPP architecture, the NWDAF (which is defined in 3GPP TS 23.288 v17.2.0) provides analytic output to one or more Analytics Consumer NFs based on data collected from one or more Data Producer NFs.

Support for Location Services are specified in 3GPP TS 23.273 (e.g., version 17.2.0).

### SUMMARY

As part of Release 18 work, the Radio Access Network (RAN) is expected to study Artificial Intelligence (AI) or Machine Learning (ML) based positioning which would allow the UE and/or RAN to utilise AI/ML models to improve the accuracy of the location determination or estimation.

In addition, the UE, when providing measurement reports to the Location Management Function (LMF), includes an indicator as to whether its location measurement, or position measurement, was based on line-of-sight (LOS) or non-line-of-sight (NLOS) measurements or communication with a Radio Access Network, RAN, node in the wireless communication network.

This disclosure addresses how such information can be used by the LMF to improve the location accuracy by leveraging analytics from the NWDAF and to determine whether a UE should use an AI/ML model for improved accuracy in the location estimation.

Disclosed herein are procedures specifying how the LMF/RAN may determine in which locations to use AI/ML based positioning, how the LMF/RAN identify what AI/ML models to use for AI/ML based positioning, and how the UEs can assist in AI/ML based positioning.

In an aspect, there is provided a method for a Location Management Function, LMF, in a wireless communication network, the method comprising: receiving a first request to provide a location of one or more user equipment, UEs, wherein the request includes a first requirement for a minimum location accuracy; for the one or more UEs and/or for a target area in which the one or more UEs are located, acquiring statistics or a prediction that location measurements are based on line-of-sight, LOS, or non-line-of-sight, NLOS, communication with a Radio Access Network, RAN, node in the wireless communication network; responsive to receiving the statistics or the prediction, determining that the one or more UEs are to use an Artificial Intelligence/Machine Learning, AI/ML, model to perform a location measurement; and sending a request to the one or more UEs for the one or more UEs to perform a location measurement using the AI/ML model.

The statistics or the prediction may comprise one or more parameters selected from a group of parameters consisting of: a location measurement ratio that includes a ratio of LOS versus NLOS based location measurements; a LOS or NLOS measurement percentage that includes a percentage of location measurements that are based on LOS or NLOS communication with a RAN node in the wireless communication network; an indication as to whether a behaviour of taking LOS or NLOS based location measurements is static or dynamic; and a prediction that NLOS based location measurements will be performed when a UE or a group of UEs enter a new service area.

The determining that the AI/ML model is to be used for location measurement may be performed in response to the received statistics or the prediction indicating that the first requirement cannot be met due to exceeding pre-configured threshold criteria.

The method may further comprise receiving, from the one or more UEs, an indication that the one or more UEs have a capability to perform location measurements using an AI/ML model. The indication may include one or more indications selected from a group of indications consisting of: an indication that AI/ML based positioning is supported by the one or more UEs; a list of the AI/ML models supported by the one or more UEs; a list of trained AI/ML models stored at or accessible by the one or more UEs; and any combination thereof. The method may further comprise sending, to the one or more UEs, a request for the one or more UEs to provide the indication that the one or more UEs have a capability to perform location measurements using an AI/ML model. The indication may include a list of the AI/ML models supported by the one or more UEs or a list of trained AI/ML models stored at or accessible by the one or more UEs. The method may further comprise selecting an AI/ML model from the list. The request for the one or more UEs to perform a location measurement using the AI/ML model may indicate the selected AI/ML model.

The request for the one or more UEs to perform a location measurement using the AI/ML model may include a minimum confidence level for providing positioning measurements using AI/ML models.

The method may further comprise, responsive to sending the request to the one or more UEs for the one or more UEs to perform a location measurement using the AI/ML model, receiving, from the one or more UEs, one or more location measurements. The method may further comprise receiving, from the one or more UEs, an indication of the accuracy of the one or more location measurements. The method may further comprise determining an accuracy of the received one or more location measurements.

The acquiring of the statistics or the prediction may comprise sending, to a network data analytics function, NWDAF, in the wireless communication network, a request for the statistics or the prediction, and receiving, from the NWDAF, the statistics or prediction. The request for the statistics or the prediction sent to the NWDAF may comprise one or more parameters to be used to determine the statistics or prediction. The one or more parameters may include one or more parameters selected from a group of parameters consisting of: a target area; a target UE, a group of UEs, or an indication that any UE is to be considered; a time of day; a number of samples to use or a confidence level; a threshold, indicating to the NWDAF to report the statistics or prediction only when the threshold is reached; or an aperiodic or periodic analytical indication.

In a further aspect, there is provided a method for performance in wireless communication network, the method comprising: sending, by a network data analytics function, NWDAF, to a Location Management Function, LMF, serving one or more user equipment, UEs, a request for information indicative of a type of measurements performed by the one or more UEs when the one or more UEs report location information; responsive to receiving the request, collecting, by the LMF, from the one or more UEs or from a RAN node, one or more location measurements for the one or more UEs and an indication as to whether the one or more location measurements are based on line-of-sight, LOS, or non-line-of-sight, NLOS, communication with the RAN node; providing, by the LMF, to the NWDAF, an indication of the type of measurements performed; and, using the type of measurements performed, deriving, by the NWDAF, for the one or more UEs, statistics or a prediction that location measurements are based on LOS or NLOS communication with the RAN node.

This method may be performed in conjunction with the method of the preceding aspect to derive the statistics or the prediction acquired by the LMF.

In a yet further aspect, there is provided a Location Management Function, LMF, for use in a wireless communication network, the LMF being arranged to: receive a first request to provide a location of one or more user equipment, UEs, wherein the request includes a first requirement for a minimum location accuracy; for the one or more UEs and/or for a target area in which the one or more UEs are located, acquire statistics or a prediction that location measurements are based on line-of-sight, LOS, or non-line-of-sight, NLOS, communication with a Radio Access Network, RAN, node in the wireless communication network; responsive to receiving the statistics or the prediction, determine that the one or more UEs are to use an Artificial Intelligence/Machine Learning, AI/ML, model to perform a location measurement; and send a request to the one or more UEs for the one or more UEs to perform a location measurement using the AI/ML model.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus will now be described, by way of example only, with reference to the accompanying drawings, in which:

FIG. 1a illustrates schematically a wireless communications network;

FIG. 1b illustrates schematically an architecture for supporting location services in 5GS;

FIG. 2 schematically illustrates a user equipment (UE) apparatus;

FIG. 3 schematically illustrates a RAN node;

FIG. 4 is a process flow chart showing certain steps of a method performed in a wireless communication network;

FIG. 5 is a schematic illustration showing a system for implementing the method of FIG. 4;

FIG. 6 is a process flow chart showing certain steps of a method for an LMF in a wireless communication network; and

FIG. 7 is a schematic illustration showing a system which may implement the method of FIG. 6.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but is not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

When a consumer requests analytics from an NWDAF, the consumer may include in the request a target area and/or a target UE or group of UE(s). The NWDAF derives analytics by collecting data/events from one or more Network Functions ensuring the data are from the target area requested or involve the target UE(s). The analytics are derived taking into account a static location of UEs based on AMF determining a UE entering or leaving a specific area of interest with a granularity of Tracking Area(s) or Cell ID(s).

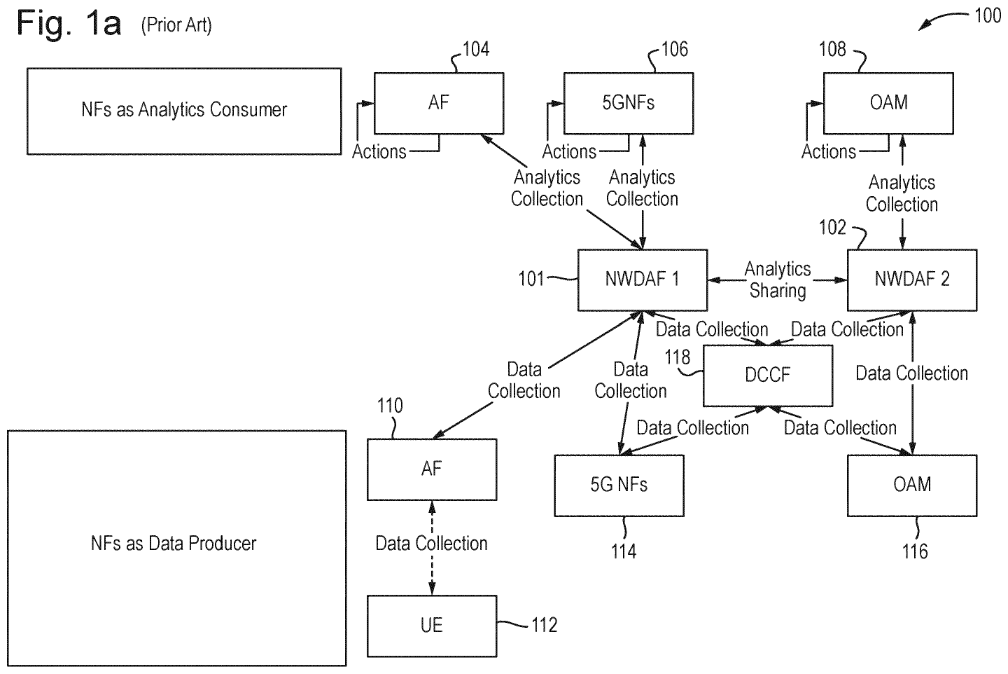

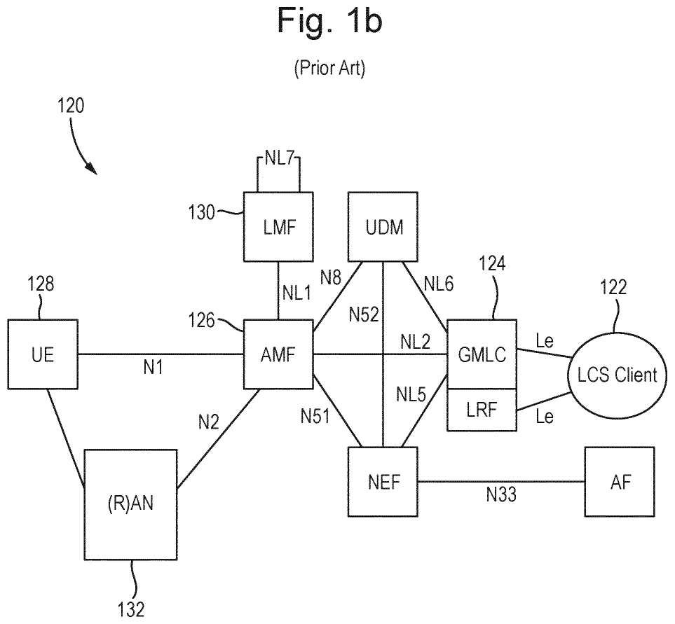

In Release 16 and Release 17 3GPP architecture, the NWDAF (which is defined in 3GPP TS 23.288 v17.2.0) provides analytic output to one or more Analytics Consumer NFs based on data collected from one or more Data Producer NFs. This is illustrated schematically in FIG. 1a.

FIG. 1a is a schematic illustration showing a wireless communications network 100 in which a first NWDAF 101 and a second NWDAF 102 provides analytic output to one or more Analytics Consumer NFs (including an Analytics Consumer Application Function (AF) 104, an Analytics Consumer 5G NF 106, and an Analytics Consumer Operations and Maintenance (OAM) module 108) based on data collected from one or more Data Producer NFs (including a Data Producer AF 110, a UE 112, a Data Producer 5G NF 114, and a Data Producer OAM 116). In the example shown in FIG. 1a, data collection may be implemented or coordinated between Data Producers 114 and 116 and the NWDAFs 101, 102 by a Data Collection Coordination Function 118.

The support of Location Services in 5GS work in 3GPP is specified in 3GPP TS 23.273 (such as version 17.2.0). The architecture for supporting location services in 5GS is as shown schematically in FIG. 1b.

In the example wireless communications network 120 shown in FIG. 1b, a location request (Le) is sent from a location services (LCS) client 122 and is received by a Gateway Mobile Location Centre (GMLC) 124. The GMLC 124 is responsible to validate the request and forward the request to an AMF 126 serving the UEs (such as UE 128) whose location is requested. The AMF 126 selects an LMF 130 for collection of location events from target UEs (such as UE 128). The LMF 130 manages the overall coordination and scheduling of resources required for the location for the UE 128. The LMF 130 receives location requests for a target UE 128 from the serving AMF 126 using the Nlmf interface. The LMF 130 interacts with the UE 128 or the RAN 132 according to the location method used. This is done in order to exchange location information applicable to UE 128. The UE 128 and/or RAN 132 and LMF 130 exchange positioning information via control plane signaling by supporting the LTE Positioning Protocol (LPP) when the UE 128 is served by an LTE access or New Radio Positioning Protocol (NRPPa) when the UE 128 is served by New Radio (NR) access.

The RAN 132 or LMF 130 determines the location of UE 128 by collecting measurements from the UE 128 utilising the LPP protocol. As of Release 17, the measurement enhancements provided by the UE 128 include an indication of whether the measurements are Line-of-Sight (LOS) or non-line-of-sight (NLOS) measurements with a node of the RAN 132. The LMF 210 and/or the RAN 132 utilise these indications to determine the accuracy of the determine UE location.

As part of Release 18, the RAN is expected to implement Artificial Intelligence and/or Machine Learning (herein referred to as “AI/ML”) based positioning which would allow the UE/RAN to utilise AI/ML models to improve the accuracy of the UE location determination. When providing measurement reports to the LMF, the UE may include an indicator that indicates whether the location measurement was based on LOS or NLOS measurements.

The below-described system and methods address how such information can be used by the LMF to improve the location accuracy by leveraging analytics from the NWDAF and determine whether a UE should use an AI/ML model for improved accuracy estimation. The below-described system and methods tend to allow for the LMF/RAN determining in which locations to use AI/ML based positioning, the LMF/RAN identifying what ML models to use for AI/ML based positioning, the UEs assisting in AI/ML based positioning.

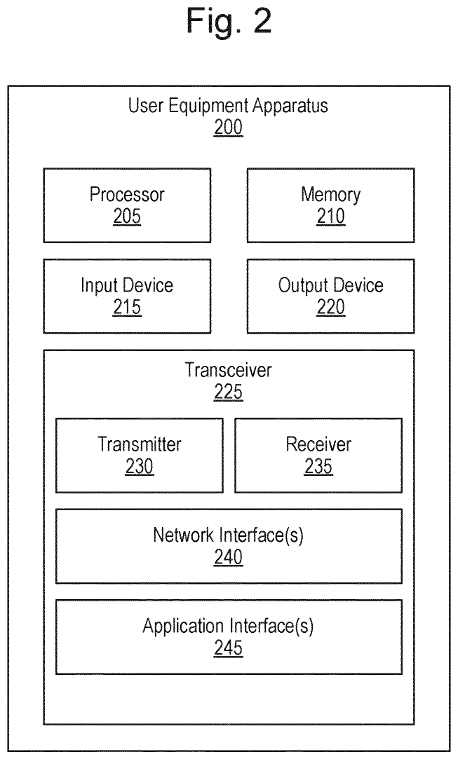

FIG. 2 depicts a user equipment apparatus 200 that may be used for implementing the methods described herein. The user equipment apparatus 200 is used to implement one or more of the solutions described above. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the above-described UE behaviors. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as describe above. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide UL communication signals to a base unit of a wireless communications network. Similarly, the one or more receivers 235 may be used to receive DL communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

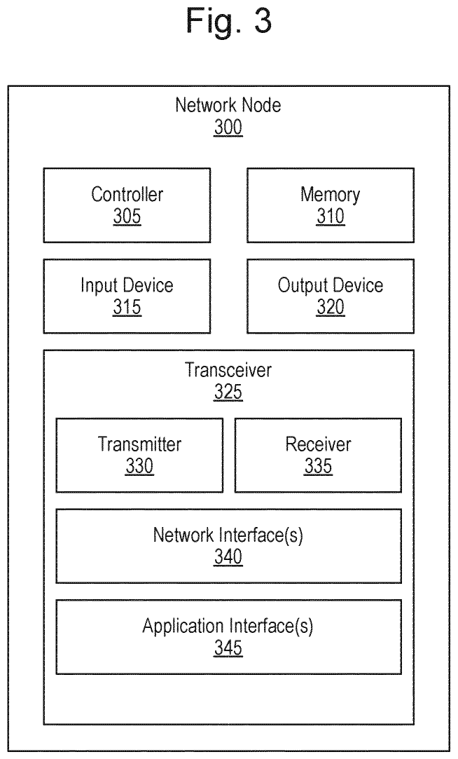

FIG. 3 depicts further details of the network node 300, such as a RAN node, that may be used for implementing the methods described herein. The network node 300 may be one implementation of an entity in the wireless communications network. The network node 300 includes a controller 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the controller 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The controller 305 may include any known controller capable of executing computer-readable instructions and/or capable of performing logical operations. For example, the controller 305 may be a microcontroller, a microprocessor, a CPU, a GPU, an auxiliary processing unit, a FPGA, or similar programmable controller. The controller 305 may execute instructions stored in the memory 310 to perform the methods and routines described herein. The controller 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described above. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

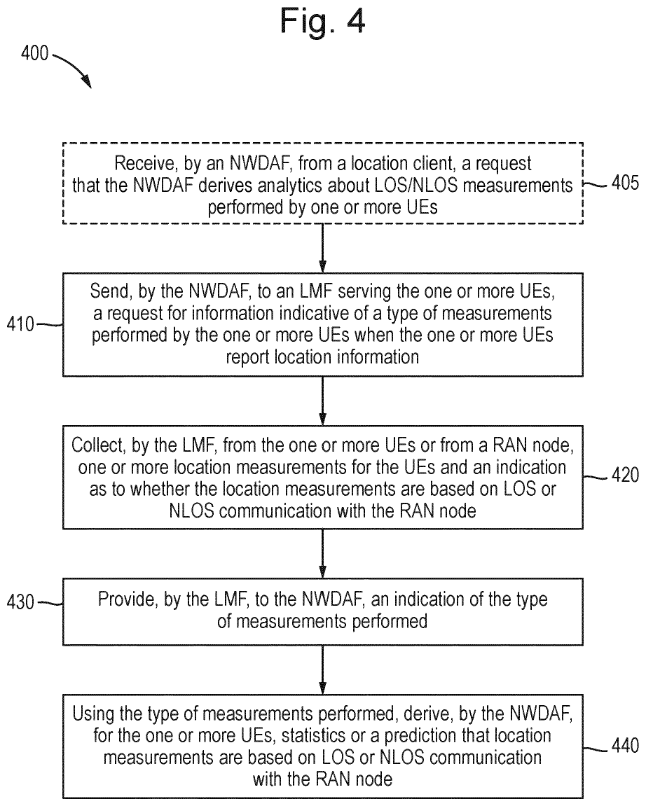

FIG. 4 is a process flow chart showing certain steps of an embodiment of a method 400 performed in a wireless communication network. The method is for analytics derivation. In this embodiment, the NWDAF is leveraged to allow a consumer (i.e., an LMF) to determine, in a particular area, when the UE provides measurement reports indicative of the UE location, whether those measurement reports are based on LOS or NLOS measurements or communication with a RAN node of the wireless communication network.

The method comprises receiving, by the NWDAF, from a consumer such as a location client (which may be an LMF), a request that the NWDAF derives analytics about a type of measurements (e.g., LOS or NLOS measurements) performed by one or more UEs when the one or more UEs report location information. Step 405 may be optional. The method 400 further comprises sending 410, by the NWDAF, to an LMF serving one or more UEs, a request for information indicative of a type of measurements (e.g., LOS or NLOS measurements) performed by the one or more UEs when the one or more UEs report location information. Step 410 may be performed responsive to step 405. The method 400 further comprises, responsive to receiving the request sent at 410, collecting 420, by the LMF, from the one or more UEs or from a RAN node, one or more location measurements for the one or more UEs and an indication as to whether the one or more location measurements are based on LOS or NLOS communication with the RAN node. The method 400 further comprises providing 430, by the LMF, to the NWDAF, an indication of the type of measurements performed by the one or more UEs. The method further comprises, using the type of measurements performed, deriving 440, by the NWDAF, for the one or more UEs, statistics or a prediction (i.e., analytics) that location measurements are based on LOS or NLOS communication with the RAN node.

The statistics or predictions (i.e., analytics) provided by the NWDAF may include, but are not limited to, one or more parameters selected from the group consisting of:
a “Location Measurement Ratio” that includes a ratio of LOS versus NLOS based measurements or measurement reports provided by a UE;
a “NLOS measurement percentage” or “LOS measurement percentage” that includes a percentage of location measurements that are based on NLOS or LOS communication with a RAN node, respectively. For example, an analytics output can be that 50% of UEs in a target area will provide NLOS measurement reports;
an analytical indication as to whether the LOS or NLOS behaviour is static or dynamic depending on the objects in the environment. Said another way, a parameter may be an indication as to whether a UE behaviour of taking LOS or NLOS based location measurements is static or dynamic. For example, LOS/NLOS behaviour can be classified into short-term, medium-term, or long-term depending on the duration and validity over which the analytics are carried out. In Industrial Internet of Things (IIoT) environments, moving objects (e.g., forklifts, moving robots, and the like) can dynamically change the LOS/NLOS characteristics of the radio environment;
analytics for “NLOS prediction” that predict the NLOS measurements when a UE or group of UEs are entering a new service area. This may be a prediction that NLOS based location measurements will be performed when a UE or a group of UEs enter a new service area.

The request to the NWDAF may contain a specific Analytic ID that allows the NWDAF to determine the analytics required and the Data Producer (e.g. LMF, UE, or RAN node) that is to be used to collect data.

The request may also include, as Analytic Filters, one or more parameters selected from the group of parameters consisting of:
a target area, which may comprise or specify a geographical region bounded by latitude and longitudinal coordinates, a RAN area, e.g., a system information area, Cell ID, and/or Zone ID;
a target UE, group of UEs, or an indication that any or all UEs are to be considered;
a time of day;
a number of samples to use or a confidence level required for any analytics predictions;
a threshold (e.g. for a number of LOS and/or NLOS measurements, or of time), indicating to the NWDAF to report analytics only when the threshold is reached;
an aperiodic or periodic analytical indication, which may be based on a subscription, and/or which may depend on if the request is one-shot or based on pre-defined intervals defined by a periodicity.

When the NWDAF is requested to provide data, i.e. analytics, the NWDAF determines that data need to be collected for the type of measurements (LOS/NLOS) reported by the UE. There are a number of options for how this can be supported:
the NWDAF collects measurements from the LMF via a new SBI (the LMF reports the number of measurements provided by the UE is based on LOS/NLOS);
the NWDAF collects measurements from the UE via OAM based on MDT. The UE reports whether the measurements are based on LOS or NLOS. The NWDAF retrieves the measurements from OAM;
the NWDAF collects the measurements directly from the UE via the AF (see 3GPP TS 23.288);
the NWDAF collects measurement information from the RAN (in case the location measurement is carried out at the RAN node).

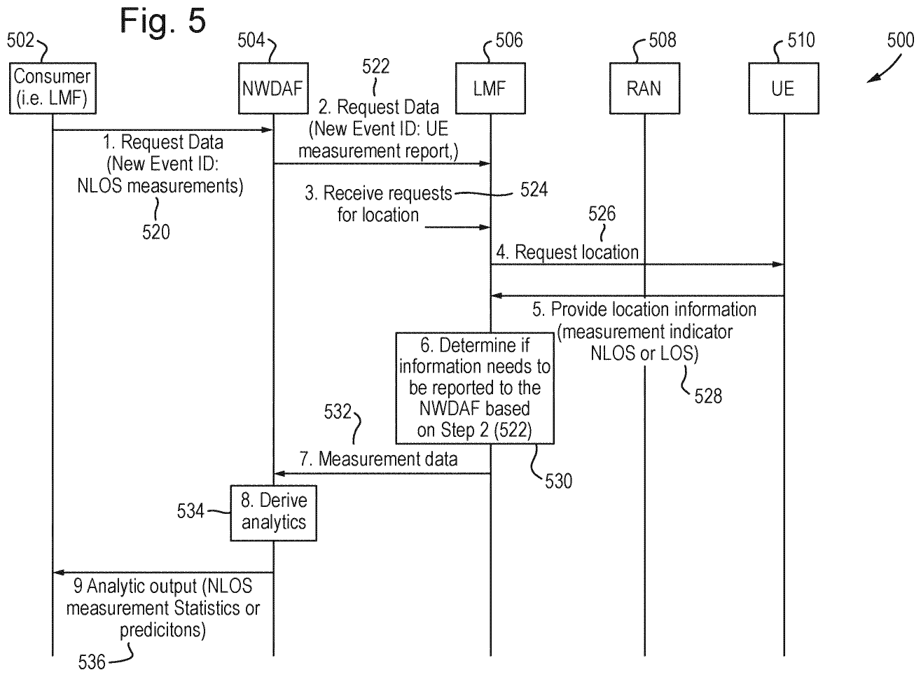

FIG. 5 is a schematic illustration showing an embodiment of a system 500 for implementing the method 400 of FIG. 4. FIG. 5 further illustrates messages that may be sent between the various entities of the system 500.

In this embodiment, the system 500 comprises a consumer, i.e. an LMF (hereinafter referred to as the “consumer LMF”) 502, an NWDAF 504, an LMF 506, a RAN 508, and a UE 510.

In this embodiment, the NWDAF 504 collects measurement information from the LMF 506. However, in other embodiments, one or more of the other data collection options may be implemented instead of or in addition to the NWDAF 504 collecting measurement information from the LMF 506.

At 520, the consumer LMF 502 sends a first request for analytics for LOS/NLOS measurements statistics or predictions to the NWDAF 504. The first request may specify a target area, a time of day, a target UE (or group of UEs or any UE), and/or a threshold to report analytic information.

At 522, the NWDAF 504 finds the LMF 506 serving the UE 510 (if the first request in step 520 specifies a target UE 510) or the LMF 506 serving a target area (if the first request in step 512 specifies any UE and a target area) and sends a second request to the LMF 506 to provide information on the type of measurements the UE 510 provides when the UE 510 reports location information. The second request may be a subscription or a one-time request. The second request may be identified by a new event exposure event ID. The second request may specify the target area, the time of day, the target UE (or group of UEs or any UE), and/or the threshold to report analytic information that was specified in the first request.

At 524, the LMF 506 receives the second request for location information for the UE 510.

At 526, the LMF 506 instructs the UE 510 to provide location information. This may be performed using the procedures described in 3GPP TS 37.355 v16.6.0. In this embodiment, the LMF 506 instructs the UE 510 to provide location information by sending a third request to the UE 510.

At 528, the UE 510 responds to the third request with location information including a location measurement. This location information includes an indication whether the location measurement is based on LOS or NLOS measurements or communication with a node of the RAN 508.

In this embodiment, as an alternative to Steps 526-528 (or in addition to steps 526-528), the LMF 506 may obtain location measurement information for the UE 510 directly from the RAN 508. The RAN 508 may indicate in the measurement information sent to the LMF 506 whether the location measurement for the UE 510 was carried out taking into account LOS and/or NLOS measurements or communication with a node of the RAN 508. The LMF 506 may obtain the location measurement information for the UE 510 directly from the RAN 508 instead of collecting the measurement information from the UE.

At 530, the LMF 506 determines if the retrieved or received measurement information needs to be reported to the NWDAF 504 in accordance with the second request received at step 524. For example, the LMF 506 may determine that the measurement information is to be reported to the NWDAF 504 in response to it determining that the UE that reported the measurement information is within the group of target UE(s) specified in the second request, or in response to determining that the location of the UE that reported the measurement information is in the target area specified in the second request.

At 532, responsive to determining that the measurement information is to be reported to the NWDAF 504, the LMF 506 provides the measurement information to the NWDAF 504.

At 534, the NWDAF 504 derives analytics for LOS/NLOS measurements from the received measurement information. This may be performed in accordance with the first request.

At 536, the NWDAF 504 sends the derived analytics to the consumer LMF 502.

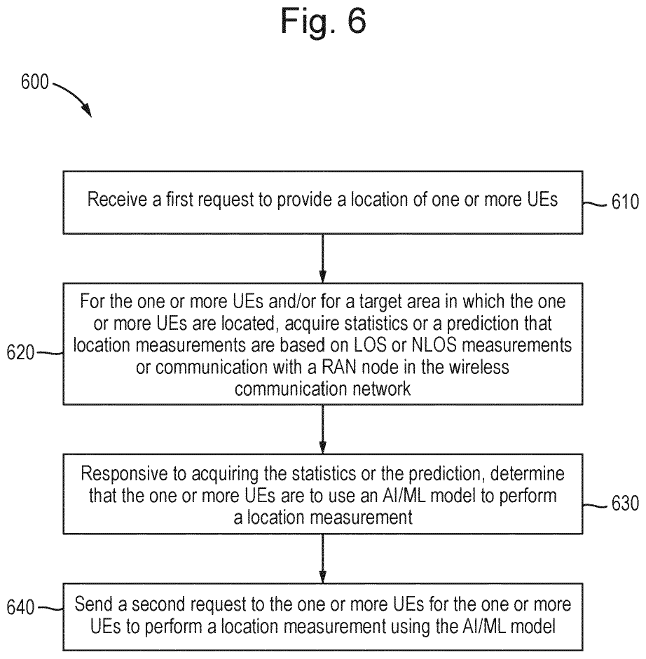

FIG. 6 is a process flow chart showing certain steps of an embodiment of a method 600 for an LMF in a wireless communication network. The method may be one by which the LMF may determine if a UE is configured to apply AI/ML models for positioning by requesting from the UE its capabilities.

The method comprises receiving 610 a first request to provide a location of one or more UEs. The request includes a first requirement for a minimum location accuracy. The method further comprises, for the one or more UEs and/or for a target area in which the one or more UEs are located, acquiring 620 statistics or a prediction that location measurements are based on LOS or NLOS measurements or communication with a RAN node in the wireless communication network. The method further comprises, responsive to acquiring the statistics or the prediction, determining 630 that the one or more UEs are to use an AI/ML model to perform a location measurement. The method further comprises sending 640 a request to the one or more UEs for the one or more UEs to perform a location measurement using the AI/ML model.

The statistics or the prediction may comprise one or more parameters selected from the group of parameters consisting of:
a “Location Measurement Ratio” that includes a ratio of LOS versus NLOS based location measurements or measurement reports provided by a UE;
a “NLOS measurement percentage” or “LOS measurement percentage” that includes a percentage of location measurements that are based on NLOS or LOS communication with a RAN node, respectively;
an analytical indication as to whether the LOS or NLOS behaviour is static or dynamic which may depend on the objects in the environment; and
a prediction that NLOS based location measurements will be performed when a UE or a group of UEs enter a new service area. This may include analytics for “NLOS prediction” that predicts the NLOS measurements when a UE or group of UEs are entering a new service area

The determining 630 that the AI/ML model is to be used for location measurement may be performed in response to the acquired or received statistics or the prediction indicating that the first requirement cannot be met. Indicating that the first requirement cannot be met may be determined by determining that the acquired or received statistics or the prediction satisfy one or more pre-determined criteria, such as exceeding a pre-configured threshold criterion.

The method 600 optionally may further comprise receiving, by the LMF, from the one or more UEs, an indication that the one or more UEs have a capability to perform location measurements using an AI/ML model. This indication may include one or more indications selected from the group of indications consisting of:
an indication that AI/ML based positioning is supported by the one or more UEs;
a list of the AI/ML models supported by the one or more UEs;
a list of trained AI/ML models stored at or accessible by the one or more UEs; and
any combination thereof.

The method 600 may further comprise the LMF sending, to the one or more UEs, a request for the one or more UEs to provide the indication that the one or more UEs have a capability to perform location measurements using an AI/ML model.

In embodiments in which the indication includes a list of the AI/ML models supported by the one or more UEs or a list of trained AI/ML models stored at or accessible by the one or more UEs, the method 600 may further comprise selecting an AI/ML model from the list. The LMF or another entity may select an AI/ML model from the list. The request for the one or more UEs to perform a location measurement using the AI/ML model may indicate the selected AI/ML model that the UE is to use. The UE uses the indicated selected AI/ML model in its location determination. Thus, in some embodiments, the LMF instructs or requests the one or more UEs to use, for location determination, a trained AI/ML model from the trained AI/ML models available to the one or more UEs.

The request for the one or more UEs to perform a location measurement using the AI/ML model may include a minimum confidence level for providing positioning measurements using AI/ML models.

The method 600 may further comprise, responsive to sending the request to the one or more UEs for the one or more UEs to perform a location measurement using the AI/ML model, the LMF receiving, from the one or more UEs, one or more location measurements. These location measurements may have been determined in accordance with the selected AI/ML model and/or the indicated minimum confidence level for providing positioning measurements using AI/ML models. The LMF may further receive, from the one or more UEs, an indication of the accuracy of the one or more location measurements. This accuracy may be specified in a received measurement report. The method may further comprise the LMF determining an accuracy of the received one or more location measurements.

In some embodiment, the acquiring of the statistics or the prediction comprises the LMF sending, to a NWDAF, in the wireless communication network, a request for the statistics or the prediction and subsequently receiving, from the NWDAF, the requested statistics or prediction. This may be performed as described in more detail earlier above with reference to FIGS. 4 and 5. As noted above, the request for the statistics or the prediction sent to the NWDAF may comprise one or more parameters to be used to determine the statistics or prediction, the one or more parameters including one or more parameters selected from the group of parameters consisting of:
a target area;
a target UE, a group of UEs, or an indication that any UE is to be considered;
a time of day;
a number of samples to use or a confidence level;
a threshold (e.g. for a number of LOS and/or NLOS measurements, or of time), indicating to the NWDAF to report the statistics or prediction only when the threshold is reached; or
an aperiodic or periodic analytical indication.

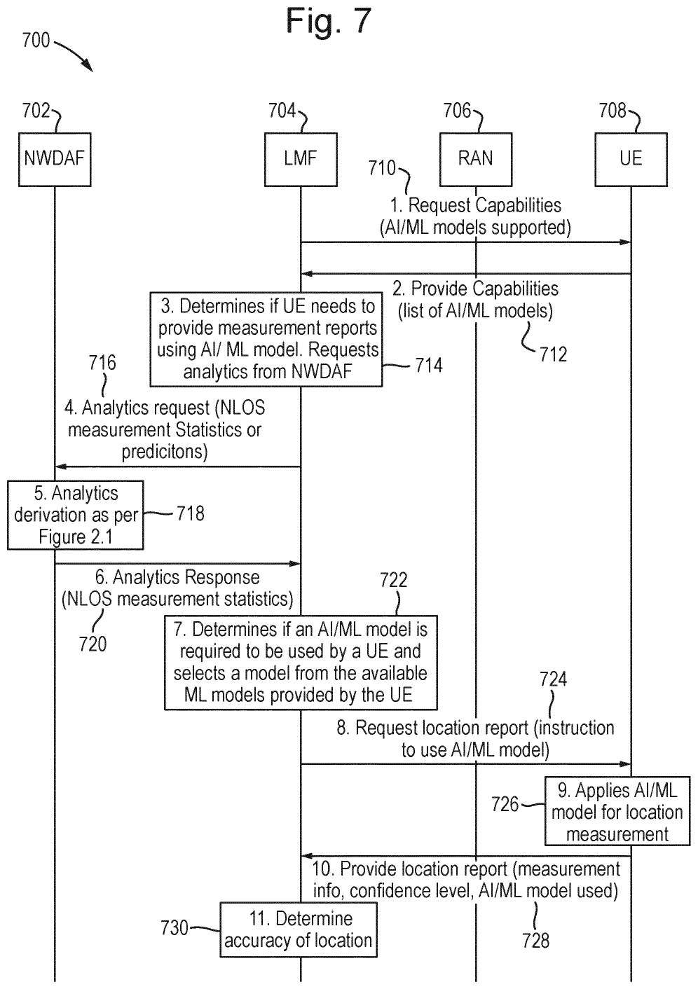

FIG. 7 is a schematic illustration showing an embodiment of a system 700 which may implement the method 600 of FIG. 6. FIG. 7 further illustrates messages that may be sent between the various entities of the system 700.

In this embodiment, the system 700 comprises an NWDAF 702, an LMF 704, a RAN 706, and a UE 708.

At 710, the LMF 704 requests the UE 708 to provide its capabilities for location measurement, e.g., using the procedure described in 3GPP TS 37.355 v16.6.0. The LMF 704 additionally requests the UE to provide its AI/ML model capabilities for positioning.

At 712, the UE 708 provides a list of AI/ML models for positioning available in the response to step 710. The list of AI/ML models may be a list of AI/ML models for positioning that are already trained. Alternatively or additionally, the UE 708 may report to the LMF 704 that it has capability for AI/ML based positioning. In such embodiments, how the UE uses the AI/ML model for location measurement is up to implementation.

At 714, the LMF 704 determines if the UE 708 is to apply an AI/ML model for positioning. The LMF 704 determines to request analytics from the NWDAF 702 to identify statistics on LOS/NLOS measurement in the target area in which the UE 708 is located, or for the specific UE 708.

Thus, in this embodiment, the LMF 704 determines if the UE 708 is configured to apply AI/ML models for positioning by requesting from the UE 708 its capabilities. The UE can provide its AI/ML capabilities using any appropriate methodology, such one or more methodologies selected from the group consisting of:
the UE 708 provides to the LMF 704 an indication that AI/ML based positioning is supported;
the UE 708 provides to the LMF 704 a list of the AI/ML models supported by the UE 708;
the UE 708 provides to the LMF 704 a list of trained AI/ML models stored at or accessible by the UE 708; and
a combination of the above.

At 716, the LMF 704 requests analytics from the NWDAF 702 on NLOS and/or LOS measurement statistics/predictions. Thus, the LMF 704 requests from the NWDAF 702 data specifying statistics or a prediction that location measurements of the UE 708 are based on LOS or NLOS communication with a node of the RAN 706. At 718, the NWDAF 702 derives (or the NWDAF 702 has previously derived) the requested analytics, i.e. the statistics or the prediction, as described in more detail earlier above with reference to FIGS. 4 and 5.

At 720, the NWDAF 702 provides to the LMF 704 the statistics or predictions on LOS/NLOS characteristics of a particular target area, or specific UE, based on the provided measurements.

In this embodiment, steps 710, 712, and 714 are performed prior to steps 716, 718, and 720. However, in other embodiments, some embodiments, steps 716, 718, and 720 may be carried out in advance by the LMF 704 before the UE 708 provides any capabilities, e.g. in advance of steps 710, 712, and 714. In such cases, the LMF 704 may subscribe from analytics from the NWDAF 702, and may include in its request to the NWDAF 702 an indication to report analytics only if a threshold is crossed, e.g., an indication or instruction that the NWDAF 702 should report analytics to the LMF 704 only if the NLOS measurements statistics exceed a threshold value, e.g. 60% of measurements.

At 722, the LMF 704 determines, based on the analytics received, if an AI/ML model for positioning is to be used by the UE 708 for location measurements. If it is determined that an AI/ML model is to be applied, the LMF 704 may select an applicable AI/ML model from the list of AI/ML models provided by the UE at 712. In some embodiments, the LMF 704 may include a trained AI/ML model for the UE 708 to apply when carrying out AI/ML based positioning measurements. Alternatively, the LMF 704 may specify to the UE 708 that the UE 708 is to provide measurement reports using AI/ML based positioning. The LMF 704 may include, in the request to the UE 708, a minimum measurement accuracy/confidence level for applying AI/ML based positioning. In such implementations, the UE 708 may initiate AI/ML based positioning based on the available AI/ML models at the UE 708. Also, the core network has no information as to what AI/ML models the UE 708 uses for AI/ML based positioning but is only informed of the accuracy/confidence of the positioning measurement.

In some embodiments, the LMF 704 also provides to the UE 708 a configuration to apply an AI/ML model for inferring position. The configuration for an AI/ML model may include one or more data selected from the group of data consisting of:
Input configuration data. This may specify a number of NLOS measurements for input to AI/ML model; and
Output configuration data. This may specify a minimum guaranteed accuracy of the inferred position.

At 724, the LMF 704 instructs the UE 708 to provide location measurement reports with the procedure described in 3GPP TS 37.355. The LMF 704 additionally includes an indication to provide measurement reports using AI/ML based positioning based on the determination at step 722. The LMF 704 may include in the request a minimum accuracy for the measurement/confidence level.

Thus, in this embodiment, based on the UE capabilities, the LMF 704 may trigger the UE to initiate AI/ML based positioning. A trigger can be based on any appropriate data or event, such as the analytics derived by the NWDAF 404 at step 718. Using such analytics, the LMF 704 may determine that in a specific area, the UEs provide more NLOS based-measurements rather than LOS based-measurements. In such a case, the LMF 704 can trigger the UE 708 to initiate AI/ML based positioning.

In some embodiments, the LMF 704 determines whether the UE 708 is to apply AI/ML model is when a percentage, a ratio, or a number of NLOS measurements in comparison to overall measurements is are above a certain threshold

At 726, the UE 708 uses the AI/ML model to provide location reports. The UE 708 provides the measurement reports by applying an AI/ML model.

At 728, the UE reports the measurements or measurement reports to the LMF 704. The UE 708 may include, in the response to the LMF 704, the accuracy/confidence of the measurement or measurements taking into account the AI/ML model and the AI/ML model used for the measurement.

At 730, the LMF 704 uses the information provided by the UE 708 to determine the accuracy of the determined UE location. The accuracy of the location may be determined or reported as horizontal accuracy and/or vertical accuracy (e.g. measured in metres). As an example, the LMF 704 may indicate that the location of a UE is at geographical point X with a horizontal accuracy of 2 m; this means that the UE may be in an area with an accuracy of 2 m radius from the location specified (point X).

In some alternative embodiments, when the LMF 704 queries the UE 708 for its capabilities (i.e., at step 710), the LMF 704 may request the UE 708 to provide information specifying which AI/ML models are supported by the UE 708 for positioning. In such embodiments, in the response (i.e., at step 712), the UE 708 provides a list of AI/ML model(s) supported and may also include information on trained AI/ML models stored/available at the UE 708.

Based on the information provided by the UE 708, when the LMF 704 determines that an AI/ML model is to be used by the UE 708, as in step 722, the LMF 704 sends a request to the UE 708, as in step 724. The request may include the AI/ML model to use and may also provide the trained AI/ML mode (if not stored at the UE 708).

In some embodiments, the UE 708 provides its supported AI/ML models for positioning within the UE radio capabilities during registration with the network. The UE 708 may include in the radio capability the list of trained AI/ML models currently available at the UE 708. The radio capabilities may be stored at the AMF. When the LMF 704 needs to determine the AI/ML model to use (as in step 722), the LMF 704 may query the AMF to provide the UE's supported and/or available AI/ML models. This may be provided to the LMF 704 as a list of AI/ML models for positioning and may include a specification of how each AI/ML model is used).

In some embodiments, positioning measurements may be carried out at the RAN 706. Thus, the system and procedure described in more detail earlier above with reference to FIG. 7 may be implemented with the UE 708 replaced by a RAN node.

In some embodiments, the consumer for analytics from the NWDAF on LOS/NLOS measurement can be the UE. The UE can use the analytics to determine whether an AI/ML model is to be applied. For example, responsive to the UE determining that UEs in an area use more NLOS measurements than LOS (based on analytics), the UE may apply an AI/ML based positioning method for location measurements.

The LMF 704, which is for use in a wireless communication network, is arranged to: receive a first request to provide a location of one or more UEs 708. The first request includes a first requirement for a minimum location accuracy. The LMF 704 is further arranged to, for the one or more UEs 708 and/or for a target area in which the one or more UEs 708 are located, acquire statistics or a prediction (i.e., analytics) that location measurements are based LOS or NLOS communication with a RAN node in the wireless communication network. The LMF 704 is further arranged to, responsive to acquiring (e.g., receiving from the NWDAF 702) the statistics or the prediction, determine that the one or more UEs 708 are to use an AI/ML model to perform a location measurement. The LMF 704 is further arranged to send a second request to the one or more UEs for the one or more UEs to perform a location measurement using the AI/ML model.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A first network node for wireless communication, comprising:
at least one memory; and
at least one processor coupled with the at least one memory and configured to cause the first network node to:
send a request for information indicative of a type of measurements performed by one or more user equipment (UEs) when the one or more UEs report location information;
collect one or more location measurements for the one or more UEs and an indication as to whether the one or more location measurements are based on line-of-sight (LOS) or non-line-of-sight (NLOS) communication with a radio access network (RAN) node; and
derive, using the type of measurements performed and for the one or more UEs, one or more of statistics or a prediction that location measurements are based on LOS or NLOS communication with the RAN node.

17. The first network node of claim 16, wherein the at least one processor is configured to cause the first network node to collect the one or more location measurements for the one or more UEs indirectly from a location management function (LMF).

18. The first network node of claim 16, wherein the one or more of the statistics or the prediction comprises one or more of:
a location measurement ratio that includes a ratio of LOS versus NLOS based location measurements;
a LOS or NLOS measurement percentage that includes a percentage of location measurements that are based on LOS or NLOS communication with a RAN node in the wireless communication network;
an indication as to whether a behavior of taking LOS or NLOS based location measurements is static or dynamic; or
a prediction that NLOS based location measurements will be performed when a UE or a group of UEs enter a new service area.

19. The first network node of claim 16, wherein the at least one processor is configured to cause the first network node to:
receive, from a second network node, a request for the one or more of the statistics or the prediction; and
transmit, to the second network node, the one or more of the statistics or the prediction.

20. The first network node of claim 19, wherein the first network node comprises a network data analytics function (NWDAF) and the second network node comprises a location management function (LMF).

21. The first network node of claim 19, wherein the request for the one or more of the statistics or the prediction comprises one or more parameters to be used to determine the one or more of the statistics or the prediction, the one or more parameters comprising one or more of:
a target area;
one or more of a target UE, a group of UEs, or an indication that any UE is to be considered;
a time of day;
one or more of a number of samples to use or a confidence level;
a threshold indicating to report the one or more of the statistics or the prediction when the threshold is reached; or
one or more of an aperiodic or periodic analytical indication.

22. The first network node of claim 21, wherein the target area comprises one or more of a region bounded by geographical coordinates, a RAN area, a cell identifier, or a zone identifier.

23. The first network node of claim 16, wherein the request for information comprises an analytic identifier for determining the one or more of the statistics or the prediction.

24. The first network node of claim 16, wherein the at least one processor is configured to cause the first network node to receive an indication of an accuracy of the one or more location measurements.

25. The first network node of claim 16, wherein the at least one processor is configured to cause the first network node to determine an accuracy of the one or more location measurements.

26. A method performed by a first network node, the method comprising:
sending a request for information indicative of a type of measurements performed by one or more user equipment (UEs) when the one or more UEs report location information;
collecting one or more location measurements for the one or more UEs and an indication as to whether the one or more location measurements are based on line-of-sight (LOS) or non-line-of-sight (NLOS) communication with a radio access network (RAN) node; and
deriving, using the type of measurements performed and for the one or more UEs, one or more of statistics or a prediction that location measurements are based on LOS or NLOS communication with the RAN node.

27. The method of claim 26, wherein the one or more of the statistics or the prediction comprises one or more of:
a location measurement ratio that includes a ratio of LOS versus NLOS based location measurements;
a LOS or NLOS measurement percentage that includes a percentage of location measurements that are based on LOS or NLOS communication with a RAN node in a wireless communication network;
an indication as to whether a behavior of taking LOS or NLOS based location measurements is static or dynamic; or
a prediction that NLOS based location measurements will be performed when a UE or a group of UEs enter a new service area.

28. The method of claim 26, further comprising:
receiving, from a second network node, a request for the one or more of the statistics or the prediction; and
transmitting, to the second network node, the one or more of the statistics or the prediction.

29. The method of claim 28, wherein the first network node comprises a network data analytics function (NWDAF) and the second network node comprises a location management function (LMF).

30. The method of claim 28, wherein the request for the one or more of the statistics or the prediction comprises one or more parameters to be used to determine the one or more of the statistics or the prediction, the one or more parameters comprising one or more of:
a target area;
one or more of a target UE, a group of UEs, or an indication that any UE is to be considered;
a time of day;
one or more of a number of samples to use or a confidence level;
a threshold indicating to report the one or more of the statistics or the prediction when the threshold is reached; or
one or more of an aperiodic or periodic analytical indication.

31. The method of claim 30, wherein the target area comprises one or more of a region bounded by geographical coordinates, a RAN area, a cell identifier, or a zone identifier.

32. The method of claim 26, wherein the request for information comprises an analytic identifier for determining the one or more of the statistics or the prediction.

33. The method of claim 26, further comprising one or more of:
receiving an indication of an accuracy of the one or more location measurements; or
determining an accuracy of the one or more location measurements.

34. A second network node for wireless communication, comprising:
at least one memory; and
at least one processor coupled with the at least one memory and configured to cause the second network node to:
receive a first request to provide a location of one or more user equipment (UEs), the first request comprising a first requirement for a minimum location accuracy;
acquire, for at least one of the one or more UEs or for a target area in which the one or more UEs are located, one or more of statistics or a prediction that location measurements are based on line-of-sight (LOS) or non-line-of-sight (NLOS) communication with a Radio Access Network (RAN) node in a wireless communication network;
determine, responsive to acquiring the one or more of the statistics or the prediction, that the one or more UEs are to use an Artificial Intelligence/Machine Learning (AI/ML) model to perform a location measurement; and
send a second request to the one or more UEs for the one or more UEs to perform a location measurement using the AI/ML model.

35. A method performed by a second network node, the method comprising:
receiving a first request to provide a location of one or more user equipment (UEs), the first request comprising a first requirement for a minimum location accuracy;
acquiring, for at least one of the one or more UEs or for a target area in which the one or more UEs are located, one or more of statistics or a prediction that location measurements are based on line-of-sight (LOS) or non-line-of-sight (NLOS) communication with a Radio Access Network (RAN) node in a wireless communication network;
determining, responsive to acquiring the one or more of the statistics or the prediction, that the one or more UEs are to use an Artificial Intelligence/Machine Learning (AI/ML) model to perform a location measurement; and
sending a second request to the one or more UEs for the one or more UEs to perform a location measurement using the AI/ML model.
